(19) United States
(12) Patent Application Publication
(10) Pub. No.: US 2024/0192724 A1
(43) Pub. Date: Jun. 13, 2024

(54) POWER SUPPLY ENHANCEMENT

(71) Applicant: TARGUS INTERNATIONAL LLC, Anaheim, CA (US)

(72) Inventors: Man Cheung Dan TSANG, Carlsbad, CA (US); David Kai Bong Mak, Rhodes (AU); Kam Shing Lee, Hong Kong (CN)

(21) Appl. No.: 18/064,897

(22) Filed: Dec. 12, 2022

(51) Int. Cl. G06F 1/16; G06F 13/38; G06F 13/42

(52) U.S. Cl. CPC G06F 1/1632; G06F 13/382; G06F 13/4282

(57) ABSTRACT

Power and data adaptors are disclosed. An example adaptor includes first and second ports configured to be coupled to an electronic device and a docking station respectively. The first port includes first data port and first power port configured to be coupled to data port and power port of the electronic device, respectively. The second port includes a second data port configured to be coupled to a data port of the docking station. The first data port receives first data from the electronic device and the second data port provides the first data to the docking station. The second data port receives second data from the docking station and the first data port provides the second data to the electronic device. The first power port supplies the power port of the electronic device with power having a first wattage greater than a second wattage supplied to the docking station.

### BACKGROUND

This disclosure generally relates to a power and data delivery system for electronic apparatuses, and, more specifically, a power and data adaptor that transmits data from/to a docking station to/from electronic apparatuses.

### BRIEF DESCRIPTION OF THE DRAWINGS

FIG. 1 is a block diagram of an exemplary power and data delivery system according to an embodiment of the present disclosure.

FIG. 2 is a block diagram of an exemplary power and data delivery system according to an embodiment of the present disclosure.

FIG. 3 is a block diagram of an exemplary power and data delivery system according to an embodiment of the present disclosure.

FIG. 4 is a block diagram of an exemplary power and data delivery system according to an embodiment of the present disclosure.

FIG. 5 is a block diagram of an exemplary power and data delivery system according to an embodiment of the present disclosure.

FIG. 6 is a block diagram of an exemplary power and data adaptor according to an embodiment of the present disclosure.

FIG. 7 is a block diagram of a power and data delivery system according to an embodiment of the present disclosure.

### DETAILED DESCRIPTION

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical, and electrical changes may be made without departing from the scope of the present disclosure. The various embodiments disclosed herein are not necessary mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known structures, materials, or operations are not shown or described in detail.

The present disclosure provides various embodiments of a power and data adaptor that may include bus ports. One of the bus ports may be coupled to an electronic device, such as a computer. Another bus port of the bus ports may be coupled to a docking station. The bus port that may be coupled to the electronic device may include a power port that may supply a power port of the electronic device with power having a first wattage that is greater than a second wattage supplied to the docking station. In some embodiments, the bus ports may be compliant with Universal Serial Bus (USB) Type-A. USB Type-B, or USB Type-C.

In some embodiments, the power and data adaptor may include a controller that provides the power having the first wattage to the power port of the electronic device. In some embodiments, the controller is coupled to a power supply unit, and may receive the power having the first wattage from the power supply unit. In some embodiments, the power and data adaptor may further include a multiplexer. The controller may control the multiplexer to receive data from the first data port coupled to the electronic device and to provide the second data port coupled to the docking station with the data from the first data port. The controller may control the multiplexer to receive data from the second data port coupled to the docking station and to provide the first data port coupled to the electronic device with the data from the second data port.

In some embodiments, the controller may supply the docking station with power having the second wattage. The controller may be coupled to a power port of the docking station. In some embodiments, the power port of the docking station may be separate from the bus port of the docking station. In some embodiments, the power port of the docking station may be included in the bus port of the docking station. In some embodiments, the controller may not supply the docking station with power having the second wattage.

In some embodiments, the power and data adaptor may include a gateway controller coupled to the controller and a network interface coupled to the gateway controller. The controller and the gateway controller may be implemented as one controller. In some embodiments, the network interface may be one or more interfaces for communication (such as, for example, packet-based communication) between the gateway controller and one or more other computers, such as a power management server coupled to the power and data adaptor and other Internet of Things (IOT) devices via one or more networks by wireless or wired internet/intranet communications. The gateway controller may communicate with the controller to monitor a status of the power usage and other electrical conditions in the power and data adaptor and provide power status information and other electrical information to the power management server via the network interface. In some embodiments, the power and data adaptor may include one or more sensors that may detect internal power usage or power consumption including devices coupled to the power and data adaptor directly or indirectly to consume power from the power and data adaptor. The power status information may be provided to the power management server. The power management server may control the power status of the power and data adaptor by providing IoT network power management information to the power and data adaptor.

In some embodiments, the controller or the multiplexer of the power and data adaptor may receive authentication information, perform authentication responsive to the authentication information and allow data and/or power transmission to/from the electronic device if the authentication is successful. In some embodiments, the authentication information may be associated with the power and data adaptor. In some embodiments, the authentication information may be related to either the electronic device or the docking station coupled to the power and data adaptor.

In some embodiments, a system may include a power supply unit and a plurality of power and data adaptors and a power supply unit that provides power having a first wattage that is greater than a second wattage supplied to a docking station.

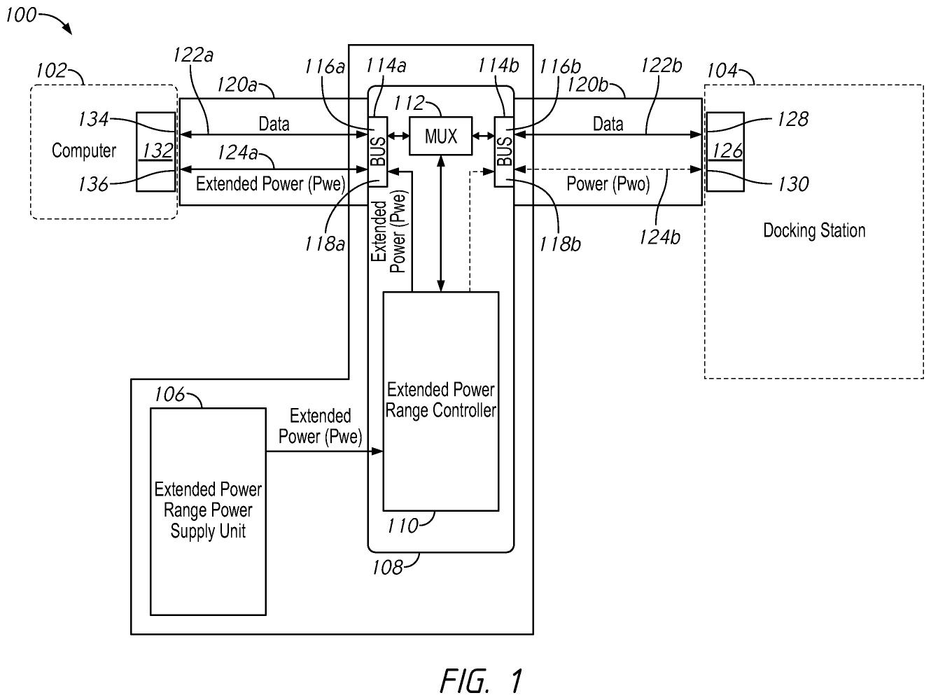

FIG. 1 is a block diagram of an exemplary power and data delivery system 100 according to an embodiment of the present disclosure. In some embodiments, the system 100 may include a power and data adaptor 108 and a power supply unit 106. The system 100 may be coupled to an electronic device, such as a computer 102 and a docking station 104.

The power and data adaptor 108 may be coupled to the computer 102 via the bus 120a. The power and data adaptor 108 may have a bus port 114a. The computer 102 may include a bus port 132. The bus ports 114a and 132 may be coupled to one another via the bus 120a. The bus port 114a may include a data port 116a. The bus 120a may include a data line 122a. The bus port 132 may include a data port 134. The data ports 116a and 134 may be coupled to one another via the data line 122a.

The computer 102 may be any computer that may consume higher computation power with complicated and high speed processing, such as graphics processing. The computer 102 may be provided with power (Pwe) with a wattage greater than a wattage of power (Pwo) supplied to the docking station 104. The computer 102 may be, for example, a work station, a desktop computer or a laptop computer that may execute video game applications, capable of data exchange with the docking station 104. The computer 102 may have a data interface, such as one or more data ports typically coupled to the docking station 104. In some embodiments, the one or more data ports may be compliant with USB Type-A. USB Type-B, or USB Type-C. In some embodiments, the one or more data ports may be proprietary to the computer 102 that may be supported by the power and data adaptor 108. The one or more data ports may include the data port 134 that may be coupled to the data port 116a of the power and data adaptor 108 via the bus 120a. In some embodiments, the bus 120a may be compliant with USB Type-A, USB Type-B, or USB Type-C. In some embodiments, the bus 120a may be proprietary to the computer 102.

The power and data adaptor 108 may be coupled to the docking station 104 via the bus 120b. The power and data adaptor 108 may have a bus port 114b. The docking station 104 may include a bus port 126. The bus ports 114b and 126 may be coupled to one another via the bus 120b. The bus port 114b may include a data port 116b. The bus 120b may include a data line 122b. The bus port 126 may include a data port 128. The data ports 116b and 128 may be coupled to one another via the data line 122b.

The power and data adaptor 108 may include a controller 110 and a multiplexer 112 that are coupled to the controller 110. The multiplexer 112 may be further coupled to each data port included in the bus ports 114a and 114b. The controller 110 may control the multiplexer 112 to receive data from the data port 116a that is coupled to the data port 134 of the computer 102, and to provide the data port 116b that is coupled to the data port 128 of the docking station 104 with the received data from the data port 116a. For example, when the docking station 104 is further coupled to a display (not shown), video data to be displayed on the display may be provided from the data port 134 on the data line 122a to the data port 116a. The multiplexer 112 may provide the video data from the data port 116b on the data line 122b to the data port 128. The docking station 104 may further provide the received video data at the data port 128 to the display for displaying the video data.

The controller 110 may control the multiplexer 112 to receive data from the data port 116b coupled to the data port 128 of the docking station 104 and to provide the data port 116a that is coupled to the data port 134 of the computer 102 with the received data from the data port 116b. For example, when the docking station 104 is further coupled to an input device, such as a mouse or a keyboard (not shown), video data to be displayed on the display may be provided from the data port 134 on the data line 122a to the data port 116a. The multiplexer 112 may provide the video data from the data port 116b on the data line 122b to the data port 128. The docking station 104 may further provide the received video data at the data port 128 to the display for displaying the video data.

The docking station 104 may include one or more ports to couple one or more devices to another computer. In some embodiments, the one or more data ports may be compliant with USB Type-A, USB Type-B, or USB Type-C. The one or more data ports may include the data port 134 that may be coupled to the data port 116b of the power and data adaptor 108 via the bus 120b. In some embodiments, the bus 120b may be compliant with USB Type-A, USB Type-B, or USB Type-C.

A device that is to be coupled to the docking station 104 is not limited to input devices, such as a mouse, a keyboard, a microphone, etc., or an output device such as a display, one or more speakers or a headphone. Any electronic device, including a smartphone, a tablet, etc., capable of data exchange with the computer 102 may be the device that is to be coupled to the docking station 104. The device to be coupled to the docking station 104 may have a data interface typically coupled to a computer. In some embodiments, one or more data ports may be compliant with USB Type-A, USB Type-B, USB Type-C, DisplayPort (DP), mini DP, High-Definition Multimedia Interface (HDMI), an audio port, etc.

The controller 110 may be coupled to the power supply unit 106. The power supply unit 106 may provide power (Pwe) having a wattage that may be greater than a wattage of power (Pwo) supplied to the docking station 104. The bus port 114a may include a power port 118a. The controller 110 may provide the power from the power supply unit 106 to the power port 118a. The bus 120a may include a power line 124a. The bus port 132 may include a power port 136. The power ports 118a and 136 may be coupled to one another via the power line 124a. Thus, the system 100 may provide the power from the power supply unit 106 to the computer 102 via the power line 124a.

The bus port 114b may include a power port 118b. The bus 120b may include a power line 124b. The bus port 126 may include a power port 130. The power ports 118b and 130 may be coupled to one another via the power line 124b. The controller 110 may or may not provide partial power (Pwo) that has a wattage of power (Pwo) supplied to the docking station 104 out of the power (Pwe) from the power supply unit 106 to the power port 118b via the power line 124b.

In some embodiments, the controller 110 may control enabling and disabling power delivery between the docking station 104 and the power and data adaptor 108. In some embodiments, the controller 110 may disable providing power from the controller 110 to the power line 124b via the power port 118b. In some embodiments, the controller 110 may disable receiving power from the power line 124b at the power port 118b. The docking station 104 may not receive power from and/or provide power to the power and data adaptor 108 on the power line 124b.

Thus, regardless of the wattage of power supplied to the docking station 104, the system 100 may provide the computer 102 with the power (Pwe) from the power supply unit 106 having the wattage greater than the wattage of power (Pwo) supplied to the docking station 104.

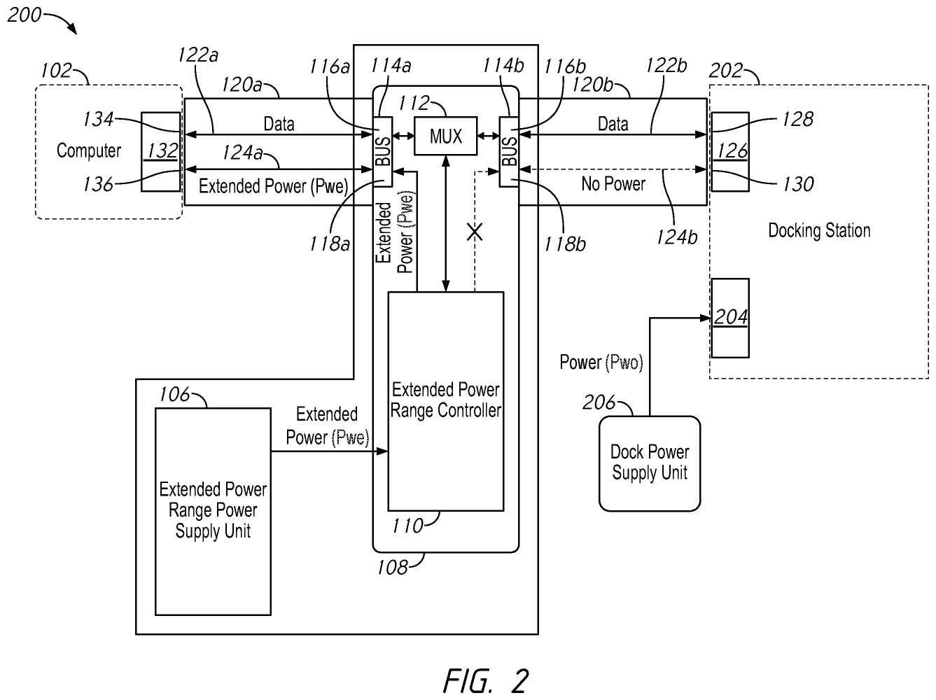

FIG. 2 is a block diagram of an exemplary power and data delivery system 200 according to an embodiment of the present disclosure. In some embodiments, the system 200 may be the system 100. The system 200 may include a power supply unit 106 and a power and data adaptor 108. In some embodiments, the power supply unit 106 and the power and data adaptor 108 in FIG. 2 may be the power supply unit 106 and the power and data adaptor 108 in FIG. 1, respectively. The power supply unit 106 and power and data adaptor 108 in FIG. 2 may include any of the features of the power supply unit 106 and power and data adaptor 108 in FIG. 1, and vice versa, respectively. Thus, a detailed description of structures of the power supply unit 106 and power and data adaptor 108 in FIG. 2 that have been previously described referring to the power supply unit 106 and power and data adaptor 108 of FIG. 1 is therefore not repeated herein for brevity.

The power and data adaptor 108 may be coupled to a docking station 202. In some embodiments, the docking station 202 may include the bus port 126 including a data port 128 and a power port 130. The docking station 202 may further include a power port 204. The power port 204 may be different from the power port 130 and separate from the bus port 126. The power port 204 may be coupled to a dock power supply unit 206. The dock power supply unit 206 may provide the power port 204 with the power (Pwo) having the wattage supplied to of the docking station 202.

In some embodiments, the bus port 126 may communicate with the bus port 114b of the power and data adaptor 108 regarding a power supply status of the docking station 202. In some embodiments, the bus port 126 may enable or disable power delivery on the power line 124b. Responsive to the power supply status of the docking station 202 or a power delivery enable/disable status of the power line 124b, the controller 110 may control enabling and disabling power delivery between the docking station 104 and the power and data adaptor 108 on the power line 124b. In some embodiments, when the docking station 202 detects the power being supplied from the dock power supply unit 206, the bus port 126 may communicate with the bus port 114b of the power and data adaptor 108 that a power supply status indicates that the power is being supplied to the docking station 202 by the dock power supply unit 206. In some embodiments, the bus port 126 may disable power delivery on the power line 124b via the power port 130. Responsive to the power supply status or the disabled power delivery, the power port 118b may disable power delivery via the power line 124b, and the controller 110 may disable providing power from the controller 110 to the power port 118b. Thus, the docking station 202 may not receive power from the power and data adaptor 108 on the power line 124b.

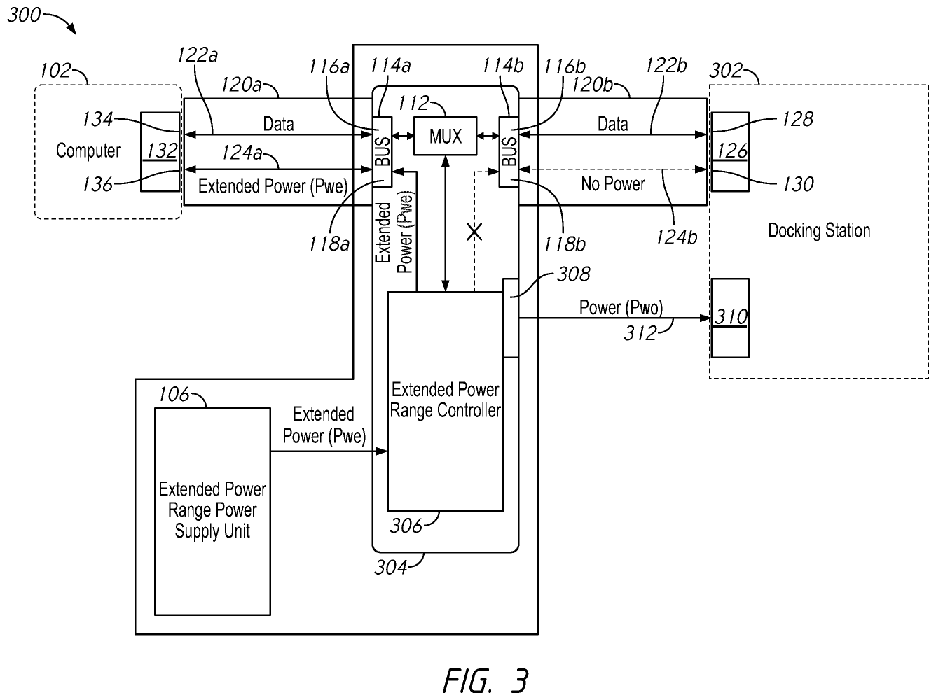

FIG. 3 is a block diagram of an exemplary power and data delivery system 300 according to an embodiment of the present disclosure. In some embodiments, the system 300 may be the system 100. The system 300 may include a power supply unit 106 and a power and data adaptor 304. In some embodiments, the power supply unit 106 and the power and data adaptor 304 in FIG. 3 may be the power supply unit 106 and the power and data adaptor 108 in FIG. 1, respectively. The power supply unit 106 and power and data adaptor 304 in FIG. 3 may include any of the features of the power supply unit 106 and power and data adaptor 108 in FIG. 1, and vice versa, respectively. Thus, a detailed description of structures of the power supply unit 106 and power and data adaptor 304 in FIG. 3 that have been previously described referring to the power supply unit 106 and power and data adaptor 108 of FIG. 1 is therefore not repeated herein for brevity.

The controller 306 may be coupled to the power supply unit 106. The power supply unit 106 may provide power having a wattage (Pwe) that may be greater than a wattage (Pwo) of power supplied to a docking station 302. The bus port 114a may include a power port 118a. The controller 306 may provide the power from the power supply unit 106 to the power port 118a. The bus 120a may include a power line 124a. The bus port 132 may include a power port 136. The power ports 118a and 136 may be coupled to one another via the power line 124a. Thus, the system 100 may provide the power from the power supply unit 106 to the computer 102 via the power line 124a. The bus port 114b may include a power port 118b. The bus 120b may include a power line 124b. The bus port 126 may include a power port 130. The power ports 118b and 130 may be coupled to one another via the power line 124b.

The power and data adaptor 304 may further include a power port 308. In some embodiments, the power port 308 may be different from the power port 118b and separate from the bus port 114b. The docking station may include a power port 310. In some embodiments, the power port 310 may be different from the power port 130 and separate from the bus port 126. The power port 308 may be coupled to the power port 310 of the docking station 302 via a power line 312.

In some embodiments, the controller 306 may control enabling and disabling power delivery between the docking station 302 and the power and data adaptor 304. In some embodiments, the controller 306 may disable providing power from the controller 306 to the power line 124b via the power port 118b. In some embodiments, the controller 306 may disable receiving power from the power line 124b at the power port 118b. The docking station 302 may not receive power from and/or provide power to the power and data adaptor 304 on the power line 124b. The controller 110 may provide partial power that has a wattage of power (Pwo) supplied to the docking station 302, less than the wattage of power (Pwe) supplied to the computer 102, from the power supply unit 106 to the power port 308. Thus, the power and data adaptor 304 may provide the power to the docking station 302 via the power line 312, without using the bus 120b.

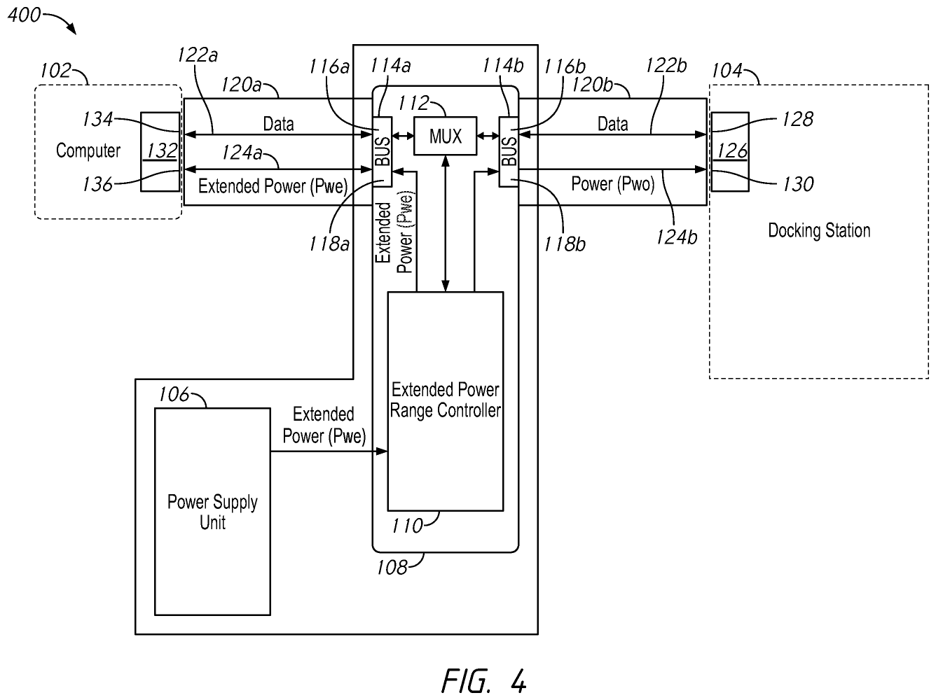

FIG. 4 is a block diagram of an exemplary power and data delivery system 400 according to an embodiment of the present disclosure. In some embodiments, the system 400 may be the system 100. The system 400 may include a power supply unit 106 and a power and data adaptor 108. In some embodiments, the power supply unit 106 and the power and data adaptor 108 in FIG. 4 may be the power supply unit 106 and the power and data adaptor 108 in FIG. 1, respectively. The power supply unit 106 and power and data adaptor 108 in FIG. 4 may include any of the features of the power supply unit 106 and power and data adaptor 108 in FIG. 1, and vice versa, respectively. Thus, a detailed description of structures of the power supply unit 106 and power and data adaptor 108 in FIG. 4 that have been previously described referring to the power supply unit 106 and power and data adaptor 108 of FIG. 1 is therefore not repeated herein for brevity.

The controller 110 may be coupled to the power supply unit 106. The power supply unit 106 may provide power (Pwe) having a wattage that may be greater than a wattage of power (Pwo) supplied to the docking station 104. The bus port 114a may include a power port 118a. The controller 110 may provide the power from the power supply unit 106 to the power port 118a. The bus 120a may include a power line 124a. The bus port 132 may include a power port 136. The power ports 118a and 136 may be coupled to one another via the power line 124a. Thus, the system 400 may provide the power (Pwe) from the power supply unit 106 to the computer 102 via the power line 124a.

The bus port 114b may include a power port 118b. The bus 120b may include a power line 124b. The bus port 126 may include a power port 130. The power ports 118b and 130 may be coupled to one another via the power line 124b. The controller 110 may provide partial power (Pwo) that has a wattage of power (Pwo) supplied to the docking station 104 to the power port 118b via the power line 124b.

In some embodiments, the controller 110 may control enabling and disabling power delivery between the docking station 104 and the power and data adaptor 108. In some embodiments, the controller 110 may enable providing power (Pwo) from the controller 110 to the power line 124b via the power port 118b. The docking station 104 may receive the power (Pwo) from the power and data adaptor 108 on the power line 124b.

Thus, regardless of the wattage of power supplied to the docking station 104, the system 100 may provide the computer 102 with the power (Pwe) from the power supply unit 106 using the bus 120a, such as a USB, and the system 100 may further provide the power (Pwo) to the docking station 104 using the bus 120b, such as a USB, without an extra power port and power line.

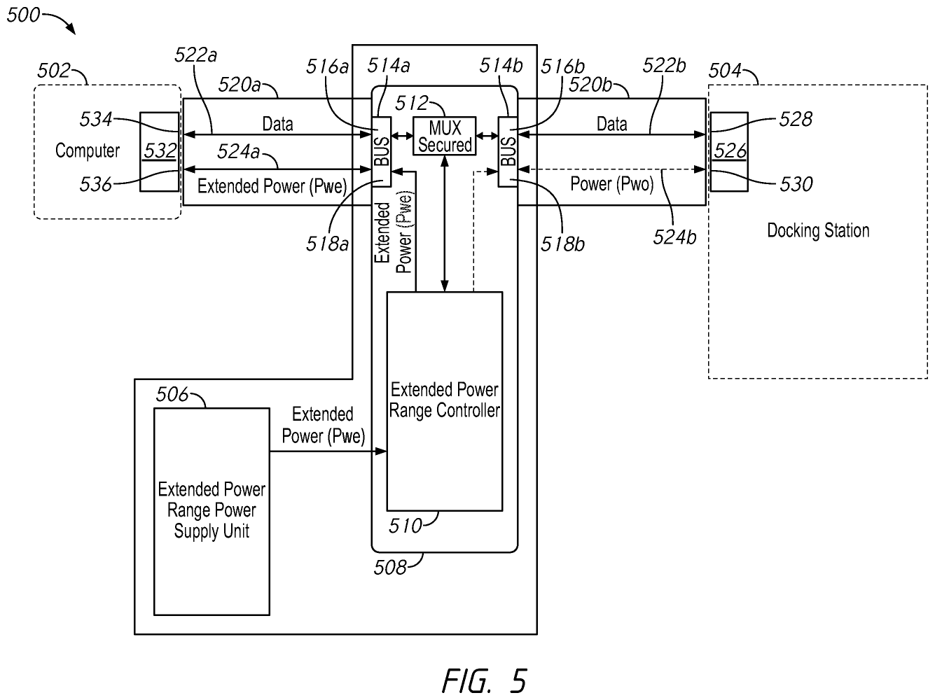

In some embodiments, a power and data adaptor that is capable of secure data exchange between authentic devices/users may be desired. FIG. 5 is a block diagram of an exemplary power and data delivery system 500 according to an embodiment of the present disclosure. In some embodiments, the system 500 may include a power and data adaptor 508 and a power supply unit 506. The system 500 may be coupled to a computer 502 and a docking station 504.

The power and data adaptor 508 may be coupled to the computer 502 via a bus 520a. The power and data adaptor 508 may have a bus port 514a. The computer 502 may include a bus port 532. The bus ports 514a and 532 may be coupled to one another via the bus 520a. The bus port 514a may include a data port 516a. The bus 520a may include a data line 522a. The bus port 532 may include a data port 534. The data ports 516a and 534 may be coupled to one another via the data line 522a.

The computer 502 may be any computer that may consume higher computation power with complicated and high speed processing, such as graphics processing. The computer 502 may be provided with power (Pwe) with a wattage greater than a wattage of power (Pwo) supplied to the docking station 504. The computer 502 may be, for example, a work station, a desktop computer or a laptop computer that may execute video game applications, capable of data exchange with the docking station 504. The computer 502 may have a data interface, such as one or more data ports typically coupled to the docking station 504. In some embodiments, the one or more data ports may be compliant with USB Type-A, USB Type-B, or USB Type-C. In some embodiments, the one or more data ports may be proprietary to the computer 502 that may be supported by the power and data adaptor 508. The one or more data ports may include the data port 534 that may be coupled to the data port 516a of the power and data adaptor 508 via the data line 522a of the bus 520a. In some embodiments, the bus 520a may be compliant with USB Type-A, USB Type-B, or USB Type-C. In some embodiments, the bus 520a may be proprietary to the computer 502.

The power and data adaptor 508 may be coupled to the docking station 504 via a bus 520b. The power and data adaptor 508 may have a bus port 514b. The docking station 504 may include a bus port 526. The bus ports 514b and 526 may be coupled to one another via the bus 520b. The bus port 514b may include a data port 516b. The bus 520b may include a data line 522b. The bus port 526 may include a data port 528. The data ports 516b and 528 may be coupled to one another via the data line 522b.

The power and data adaptor 508 may include a controller 510 and a multiplexer 512 that is coupled to the controller 510. The multiplexer 512 may be further coupled to data ports 516a and 516b included in the bus ports 514a and 514b.

When the system 500 is running in a secure mode, the controller 510 may control the multiplexer 512 to function as a secure multiplexer. In some embodiments, the controller 510 may control the multiplexer 512 to receive data from the data port 516a that is coupled to the data port 534 of the computer 502. In some embodiments, the data may be provided together with authentication information about the computer 502. Based on the authentication information about the computer 502, if either the controller 510 or the multiplexer 512 determines that the data from the computer 502 may be allowed for transmission, the multiplexer 512 may receive the data from the data port 516a. In some embodiments, the multiplexer 512 may further receive authentication information about the docking station 504 from the docking station 504. Based on the authentication information about the docking station 504, if either the controller 510 or the multiplexer 512 determines that the data may be allowed for transmission to the docking station 504, the multiplexer 512 may provide the data to the data port 516b coupled to the docking station 504.

In some embodiments, the controller 510 may control the multiplexer 512 to receive data from the data port 516b that is coupled to the data port 528 of the docking station 504. In some embodiments, the data may be provided together with authentication information about the docking station 504. Based on the authentication information about the docking station 504, if either the controller 510 or the multiplexer 512 determines that the data from the docking station 504 may be allowed for transmission, the multiplexer 512 may receive the data from the data port 516b. In some embodiments, the multiplexer 512 may further receive authentication information about the computer 502 from the computer 502. Based on the authentication information about the computer 502, if either the controller 510 or the multiplexer 512 determines that the data may be allowed for transmission to the computer 502, the multiplexer 512 may provide the data to the data port 516a coupled to the computer 502.

The docking station 504 may include one or more ports to couple one or more devices to another computer. In some embodiments, the one or more data ports may be compliant with USB Type-A, USB Type-B, or USB Type-C. The one or more data ports may include the data port 534 that may be coupled to the data port 516b of the power and data adaptor 508 via a data line 522b of the bus 520b. In some embodiments, the bus 520b may be compliant with USB Type-A, USB Type-B, or USB Type-C.

A device that is to be coupled to the docking station 504 is not limited to input devices, such as a mouse, a keyboard, a microphone, etc., or an output device such as a display, one or more speakers or a headphone. Any electronic device, including a smartphone, a tablet, etc., capable of data exchange with the computer 502 may be the device that is to be coupled to the docking station 504. The device to be coupled to the docking station 504 may have a data interface typically coupled to a computer. In some embodiments, one or more data ports may be compliant with USB Type-A, USB Type-B, USB Type-C, DP, mini DP, HDMI, an audio port, etc.

The controller 510 may be coupled to the power supply unit 506. The power supply unit 506 may provide power (Pwe) having a wattage that may be greater than a wattage of power (Pwo) supplied to the docking station 504. The bus port 514a may include a power port 518a. The controller 510 may provide the power from the power supply unit 506 to the power port 518a. The bus 520a may include a power line 524a. The bus port 532 may include a power port 536. The power ports 518a and 536 may be coupled to one another via the power line 524a. Thus, the system 500 may provide the power from the power supply unit 506 to the computer 502 via the power line 524a, if verification with authentication information about the computer 502 is successful and power delivery is allowed.

The bus port 514b may include a power port 518b. The bus 520b may include a power line 524b. The bus port 526 may include a power port 530. The power ports 518b and 530 may be coupled to one another via the power line 524b. The controller 510 may or may not provide partial power (Pwo) that has a wattage of power (Pwo) supplied to the docking station 504 out of the power (Pwe) from the power supply unit 506 to the power port 530 via the power port 518b and the power line 524b.

In some embodiments, the controller 510 may control enabling and disabling power delivery between the docking station 504 and the power and data adaptor 508. In some embodiments, the controller 510 may enable providing power from the controller 510 to the power line 524b via the power port 518b, if verification with authentication information about the computer 502 is successful and power delivery is allowed. In some embodiments, the controller 510 may disable receiving power from the power line 524b at the power port 518b, if verification with authentication information about the computer 502 is successful and power delivery is allowed.

In some embodiments, the controller 510 may disable providing power from the controller 510 to the power line 524b via the power port 518b, if verification with authentication information about the computer 502 fails and power delivery is not allowed. In some embodiments, the controller 510 may disable receiving power from the power line 524b at the power port 518b, if verification with authentication information about the computer 502 fails and power delivery is not allowed. The docking station 504 may not receive power from and/or provide power to the power and data adaptor 508 on the power line 524b.

Thus, regardless of the wattage of power supplied to the docking station 504, the system 500 may provide the computer 502 with the power (Pwe) from the power supply unit 506 having the wattage greater than the wattage of power (Pwo) supplied to the docking station 504, depending on the result of verification with authentication information.

The authentication information about the computer 502 and the authentication information about the docking station 504 may be varied. In some embodiments, the authentication may be related to the power and data adaptor 508, such as a key associated with the power and data adaptor 508 that may decrypt encrypted data received by the multiplexer 512. In some embodiments, the authentication information about the computer 502 and the authentication information about the docking station 504 may be provided. For example, the authentication information may be a media access control (MAC) address of the computer 502 and/or a MAC address of the docking station 504. In some examples, the authentication information may be secure network login information, including a login identifier and a passcode encrypted. In some examples, the authentication information may be a passcode for application software on the computer 502 and/or a passcode of firmware on the docking station 504. In some examples, the authentication information may be an IoT remote control access information on the controller 510. In some examples, biometric information, such as fingerprint, palm print, voice, iris, retina, etc., may be collected by a sensor on the controller 510. In some embodiments, the authentication may be performed by the controller 510. The controller 510 may receive the authentication information, and perform verification based on the authentication information. The controller 510 may turn on or off a switch in the multiplexer 512 associated with a coupled device associated with the authentication information for enabling or disabling transmission of the data and power by the multiplexer 512, depending on the result of authentication.

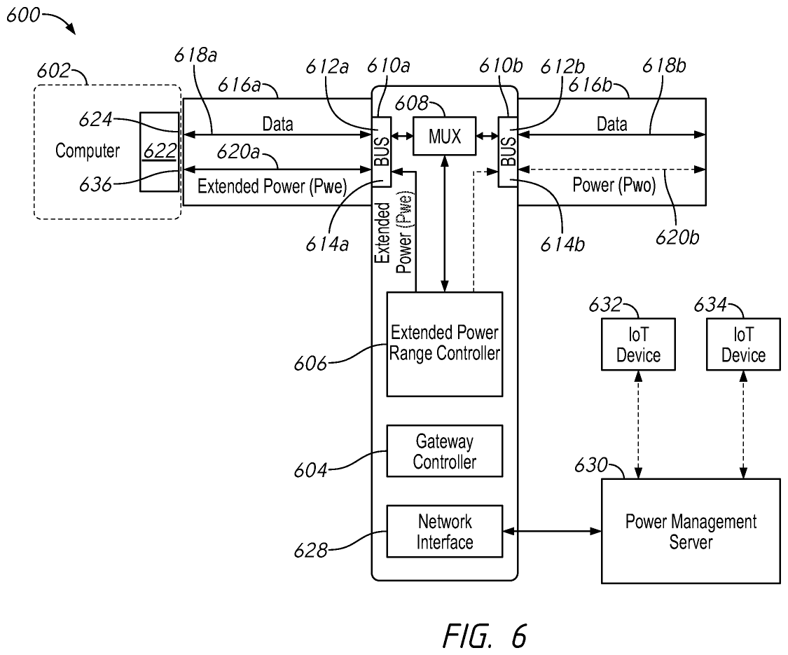

FIG. 6 is a block diagram of an exemplary power and data adaptor 600 according to an embodiment of the present disclosure. In some embodiments, the power and data adaptor 600 may be coupled to a computer 602.

The power and data adaptor 600 may be coupled to the computer 602 via a bus 616a. The power and data adaptor 600 may have a bus port 610a. The computer 602 may include a bus port 622. The bus ports 610a and 622 may be coupled to one another via the bus 616a. The bus port 610a may include a data port 612a. The bus 616a may include a data line 618a. The bus port 622 may include a data port 624. The data ports 612a and 624 may be coupled to one another via the data line 618a.

The computer 602 may be any computer that may consume higher computation power with complicated and high speed processing, such as graphics processing. The computer 602 may be provided with power (Pwe) with a wattage greater than a wattage of power (Pwo) supplied to another device (not shown), such as the docking stations 104, 202, 302, or 504. The computer 602 may be, for example, a work station, a desktop computer or a laptop computer that may execute video game applications, capable of data exchange with the other device. The computer 602 may have a data interface, such as one or more data ports typically coupled to the other device. In some embodiments, the one or more data ports may be compliant with USB Type-A, USB Type-B, or USB Type-C. In some embodiments, the one or more data ports may be proprietary to the computer 602 that may be supported by the power and data adaptor 600. The one or more data ports may include the data port 624 that may be coupled to the data port 612a of the power and data adaptor 600 via the data line 618a of the bus 616a. In some embodiments, the bus 616a may be compliant with USB Type-A, USB Type-B, or USB Type-C. In some embodiments, the bus 616a may be proprietary to the computer 602.

The power and data adaptor 600 may be coupled to another device (not shown), such as the docking stations 104, 202, 302, or 504 via a bus 616b. The power and data adaptor 600 may have a bus port 610b. The bus port 610b may be coupled to the bus 616b that is coupled to a bus port of the other device. The bus port 610b may include a data port 612b. The bus 616b may include a data line 618b. The data port 612b may be coupled to another data port of the other device via the data line 618b.

The power and data adaptor 600 may include a controller 606 and a multiplexer 608 that is coupled to the controller 606. The multiplexer 608 may be further coupled to each data port included in the bus ports 610a and 610b. In some embodiments, the controller 606 may control the multiplexer 608 to receive data from the data port 612a that is coupled to the data port 624 of the computer 602. Thus, the multiplexer 608 may receive the data from the data port 612a. In some embodiments, if either the controller 606 or the multiplexer 608 determines that the data may be allowed for transmission to the other device, the multiplexer 608 may provide the data to the power port 614b coupled to the other device. In some embodiments, the controller 606 may control the multiplexer 608 to receive data from the data port 612b that is coupled to the other device. Thus, the multiplexer 608 may receive the data from the data port 612b. In some embodiments, if either the controller 606 or the multiplexer 608 determines that the data may be allowed for transmission to the computer 602, the multiplexer 608 may provide the data to the data port 612a coupled to the computer 602.

In some embodiments, the controller 606 may provide the computer 602 with power (Pwe) having a wattage that may be greater than a wattage of power (Pwo) supplied to a device coupled via the bus 616b. The bus port 610a may include a power port 614a. The controller 606 may provide the power (Pwe) to the power port 614a. The bus 616a may include a power line 620a. The bus port 622 may include a power port 626. The power ports 614a and 626 may be coupled to one another via the power line 620a. Thus, the power and data adaptor 600 may provide the power (Pwe) to the computer 602 via the power line 620a. The bus port 610b may include a power port 614b. The bus 616b may include a power line 620b coupled to the power port 614b. The controller 606 may or may not provide partial power that has a wattage of power (Pwo) out of the power (Pwe) to/from the power port 614b coupled to the power line 620b. Thus, regardless of the wattage of power coupled to the power line 620b, the power and data adaptor 600 may provide the computer 602 with the power (Pwe) having the wattage greater than the wattage of power (Pwo) supplied to the power line 620b.

In some embodiments, the power and data adaptor 600 may include a gateway controller 604 coupled to the controller 606 and a network interface 628 coupled to the gateway controller 604. In some embodiments, the controller 606 and the gateway controller 604 may be implemented as one controller. In some embodiments, the network interface 628 may be one or more interfaces for communication (such as, for example, packet-based communication) between the gateway controller 604 and one or more other computers, such as a power management server 630. In some embodiments, the power management server 630 may be coupled to the power and data adaptor 600 and other IoT devices, such as IoT devices 632 and 634 via one or more networks by wireless or wired internet/intranet communications. The wireless communications may include, for example, Wi-Fi, a cellular telecommunication such as CDMA, GSM, EV-DO, 3G, 4G, and 5G, etc., a short distance communication such as Bluetooth, near filed communications (NFC), etc. The wired communications may include communication via an Ethernet, etc.

The gateway controller 604 may communicate with the controller 606 to monitor a status of the power usage and other electrical conditions in the power and data adaptor 600 and provide power status information and other electrical information to the power management server 630 via the network interface 628. In some embodiments, the power and data adaptor 600 may include one or more sensors that may detect internal power usage or power consumption including devices coupled to the power and data adaptor 600 directly or indirectly to consume power from the power and data adaptor 600. The power management server 630 may collect the power status information from sensors in IoT devices that communicate with the power management server 630 to assess the current power usage and/or consumption, and may further perform power management of the IoT devices based on the assessment. In some embodiments, the power management server 630 may control the power status of the power and data adaptor 600 by providing power management information to the gateway controller 604 of the power and data adaptor 600 via the network interface 628. The gateway controller 604 may communicate the power management information to the controller 606. The controller 606 may control power supply responsive to the power management information from the power management server 630. For example, the controller 606 may disable providing the power to the computer 602 when the power management server 630 provides a communication including the power management information, instructing the power and data adaptor 600 to disable supplying power, either Pwe or Pwo. By controlling IoT devices coupled to the power management server 630, excess power consumption in an entire network managed by the power management server 630 may be prevented.

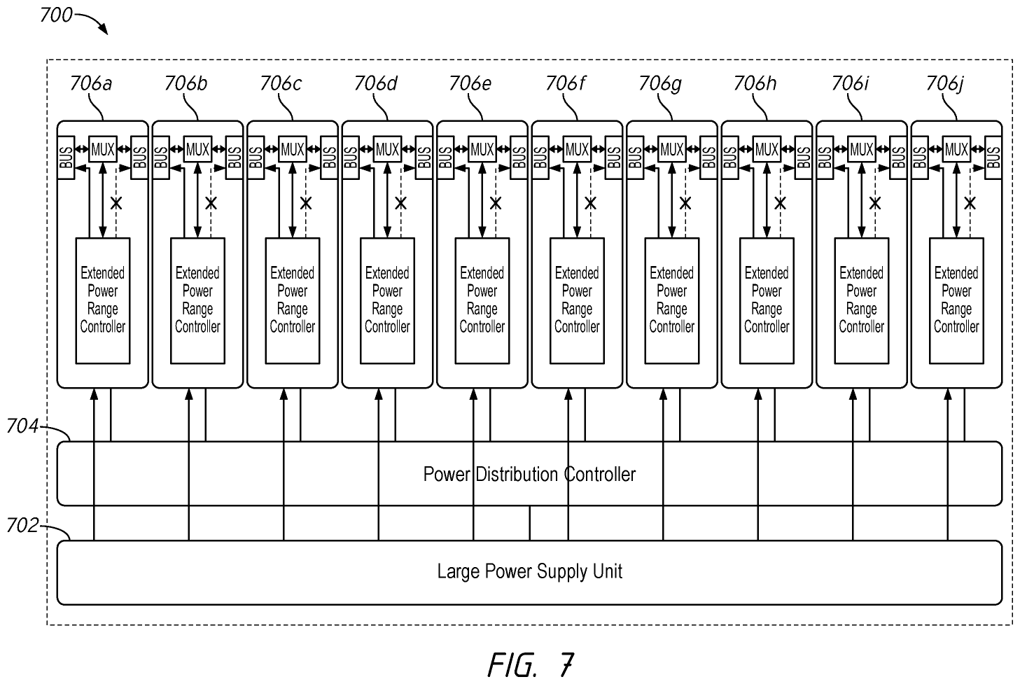

In some embodiments, a number of a power and data adaptor in a power and data delivery system may be greater than one. FIG. 7 is a block diagram of an exemplary power and data delivery system 700 according to an embodiment of the present disclosure. In some embodiments, the system 700 may include a power supply unit 702 and power and data adaptors 706a-706j.

In some embodiments, the power and data adaptors 706a-706j may be any of the power and data adaptors 108, 304, 508, and 600 in FIGS. 1-6. For example, the power and data adaptors 706a-706j may be coupled to the power supply unit 702 that may provide power, such as the power (Pwe) with a wattage greater than a wattage of power (Pwo) supplied to the docking stations in FIGS. 1-5. The power and data adaptors 706a-706j in FIG. 7 may include any of the features of any of the power and data adaptors 108, 304, 508, and 600 in FIGS. 1-6, and vice versa, respectively. Thus, a detailed description of structures of the power and data adaptors 706a-706j in FIG. 7 that have been previously described referring to the power and data adaptors 108, 304, 508, and 600 in FIGS. 1-6 is therefore not repeated herein for brevity.

In some embodiments, the system 700 may further include a power distribution controller 704 that is coupled to the power supply unit 702 and the power and data adaptors 706a-706j. The power distribution controller 704 may detect insufficient power supply, instability of power supply, excess power supply or uneven power distribution to any of the power and data adaptors 706a-706j, and control the power supply to the power and data adaptors 706a-706j to adjust power distribution of the power (Pwe) to the power and data adaptors 706a-706j. In some embodiments, as a result of the adjustment, the power distribution of the power (Pwe) to the power and data adaptors 706a-706j may be stabilized and/or balanced.

A system supplying a greater wattage to a plurality of power and data adaptors 706a-706j provides multi-channel and multi-device charging capability. In some embodiments, the system may be implemented for commercial purposes, such as charging stations, public charging spots or in-office multiple device charging systems.

In the manner described above, a power and data delivery adaptor includes a multiplexer and a controller. According to various embodiments, a system may include a power and data adaptor that may include a bus port coupled to a docking station and another bus port coupled to an electronic device that may supply a power port of the electronic device with power having a first wattage that is greater than a second wattage supplied to a docking station. In some embodiments, the bus port including a data port and a power port may be coupled to a bus compliant with an existing format. Thus multiple power profiles of electronic devices may be supported with existing bus connections.

From the foregoing it will be appreciated that, although specific embodiments of the disclosure have been described herein for purposes of illustration, various modifications may be made without deviating from the spirit and scope of the disclosure. Accordingly, the scope of the disclosure should not be limited to any of the specific embodiments described herein.

What is claimed is:

1. A power and data adaptor comprising:
a first port configured to be coupled to an electronic device, the first port comprising:
a first data port configured to be coupled to a data port of the electronic device; and
a first power port configured to be coupled to a power port of the electronic device;
a second port configured to be coupled to a docking station, the second port comprising:
a second data port configured to be coupled to a data port of the docking station,
wherein the first data port is configured to receive first data from the electronic device and the second data port is configured to provide the first data to the docking station,
wherein the second data port is configured to receive second data from the docking station and the first data port is configured to provide the second data to the electronic device, and
wherein the first power port is configured to supply the power port of the electronic device with power having a first wattage that is greater than a second wattage supplied to the docking station.

2. The power and data adaptor of claim 1, wherein the first port is compliant with Universal Serial Bus (USB) Type-A, USB Type-B, USB Type-C.

3. The power and data adaptor of claim 1, further comprising a controller configured to provide the power having the first wattage to the first power port.

4. The power and data adaptor of claim 3, wherein the controller is coupled to a power supply unit, and
wherein the controller is configured to receive the power having the first wattage from the power supply unit.

5. The power and data adaptor of claim 3, further comprising a multiplexer,
wherein the controller is configured to control the multiplexer to:
receive the first data from the first data port and to provide the second data port with the first data; and
receive second data from the second data port and to provide the first data port with the second data.

6. The power and data adaptor of claim 3, wherein the controller is configured to supply the docking station with power having the second wattage.

7. The power and data adaptor of claim 6, wherein the controller is configured to be coupled to a power port of the docking station.

8. The power and data adaptor of claim 7, wherein the second port further comprises a second power port configured to be coupled to a power port of a port of the docking station.

9. The power and data adaptor of claim 8, wherein the controller is configured to supply the second power port with power having the second wattage, and
wherein the second power port is configured to supply the power port of the docking station with the power having the second wattage.

10. The power and data adaptor of claim 8, wherein the controller is configured not to supply the second power port with power.

11. The power and data adaptor of claim 3, further comprising:
a gateway controller coupled to the controller; and
a network interface,
wherein the gateway controller is configured to communicate with the controller to monitor a status of power usage and/or electrical conditions in the power and data adaptor and further configured to provide information regarding the status of power usage and/or electrical conditions to a power management server, configured to receive power management information from the power management server, and further configured to provide the power management information to the controller, and
wherein the controller is configured to control power supply responsive to the power management information.

12. The power and data adaptor of claim 11, further comprising one or more sensors configured to detect internal power usage and/or power consumption by devices coupled to the power and data adaptor directly or indirectly to consume power from the power and data adaptor, and
wherein the gateway controller is configured to provide the information regarding the status of power usage and/or electrical conditions based on detected information by the one or more sensors.

13. The power and data adaptor of claim 5, wherein the multiplexer is configured to perform authentication responsive to authentication information from the electronic device, and further configured to allow data and/or power transmission to/from the electronic device if the authentication is successful.

14. A power and data delivery system comprising:
a power and data adaptor that comprises:
a first port configured to be coupled to an electronic device, the first port comprising:
a first data port configured to be coupled to a data port of the electronic device; and
a first power port configured to be coupled to a power port of the electronic device;
a second port configured to be coupled to a docking station, the second port comprising:
a second data port configured to be coupled to a data port of the docking station; and
a power supply unit configured to provide the power and data adaptor with power having a first wattage,
wherein the first data port is configured to receive first data from the electronic device and the second data port is configured to provide the first data to the docking station,
wherein the second data port is configured to receive second data from the docking station and the first data port is configured to provide the second data to the electronic device, and
wherein the power and data adaptor is configured to supply the power port of the electronic device from the first power port with the power having the first wattage that is greater than a second wattage supplied to the docking station.

15. The system of claim 14, wherein the power and data adaptor further comprises a controller configured to receive the power having the first wattage from the power supply unit and further configured to provide the power having the first wattage to the first power port.

16. The system of claim 15, wherein the power and data adaptor further comprises a multiplexer, and
wherein the controller is configured to control the multiplexer to:
receive the first data from the first data port and to provide the second data port with the first data; and
receive second data from the second data port and to provide the first data port with the second data.

17. The system of claim 16, wherein the multiplexer is configured to perform authentication responsive to an identifier and a passcode from the electronic device, and further configured to allow data and/or power transmission to/from the electronic device if the authentication is successful.

18. The system of claim 16, wherein the second port further comprises a second power port configured to be coupled to a power port of the docking station, and
wherein the power port of the docking station is configured to be supplied power having the second wattage.

19. The system of claim 18, wherein the controller is configured not to supply the second power port with power.

20. The system of claim 19, wherein the controller is configured to supply the docking station with power having the second wattage.

21. The system of claim 18, wherein the controller is configured to supply the second power port with power having the second wattage, and
wherein the second power port is configured to supply the power port of the docking station with the power having the second wattage.

22. The system of claim 15, the power and data adaptor further comprises:
a gateway controller coupled to the controller; and
a network interface,
wherein the gateway controller is configured to communicate with the controller to monitor a status of power usage and/or electrical conditions in the power and data adaptor and further configured to provide information regarding the status of power usage and/or electrical conditions to a power management server, configured to receive power management information from the power management server, and further configured to provide the power management information to the controller, and
wherein the controller is configured to control power supply responsive to the power management information.

23. The system of claim 22, wherein the power and data adaptor further comprises one or more sensors configured to detect internal power usage and/or power consumption by devices coupled to the power and data adaptor directly or indirectly to consume power from the power and data adaptor, and
wherein the gateway controller is configured to provide the information regarding the status of power usage and/or electrical conditions based on detected information by the one or more sensors.

24. A system comprising:
a power supply unit configured to provide power having a first wattage;
a first power and data adaptor coupled to the power supply unit, the first power and data adaptor that comprises:
a first port configured to be coupled to a first electronic device, the first port comprising:
a first data port configured to be coupled to a data port of the first electronic device; and
a first power port configured to be coupled to a power port of the first electronic device; and
a second port configured to be coupled to a second electronic device, the second port comprising:
a second data port coupled to a data port of the second electronic device; and
a second power and data adaptor coupled to the power supply unit, the second power and data adaptor that comprises:
a third port configured to be coupled to a third electronic device, the third port comprising:
a third data port configured to be coupled to a data port of the third electronic device; and
a second power port configured to be coupled to a power port of the third electronic device; and
a fourth port configured to be coupled to a fourth electronic device, the fourth port comprising:
a fourth data port coupled to a data port of the fourth electronic device,
wherein the first power and data adaptor is configured to supply the power port of the first electronic device from the first power port with the power having the first wattage that is greater than a second wattage supplied to the second electronic device, and
wherein the second power and data adaptor is configured to supply the power port of the third electronic device from the second power port with the power having the first wattage that is greater than a third wattage supplied to the fourth electronic device.

25. The system of claim 24, wherein the first data port is configured to receive first data from the first electronic device and the second data port is configured to provide the first data to the second electronic device,
wherein the second data port is configured to receive second data from the second electronic device and the first data port is configured to provide the second data to the first electronic device,
wherein the third data port is configured to receive third data from the third electronic device and the fourth data port is configured to provide the third data to the fourth electronic device, and
wherein the fourth data port is configured to receive fourth data from the fourth electronic device and the third data port is configured to provide the fourth data to the third electronic device.

26. The system of claim 24, further comprising:
a plurality of power and data adaptors coupled to the power supply unit, including the first and second power and data adaptors; and
a power distribution controller coupled to the power supply unit and the plurality of power and data adaptors, configured to detect insufficient power supply, instability of power supply, excess power supply or uneven power distribution to any of the plurality of power and data adaptors, and further configured to adjust power distribution of the power having the first wattage to the plurality of power and data adaptors.
